(19) United States
(12) Patent Application Publication
(10) Pub. No.: US 2014/0069268 A1
(43) Pub. Date: Mar. 13, 2014

(54) Projectile resistant transparent laminate

(71) Applicants: Ione Batilla Ryan, Houston, TX (US); Robert Mark Cormier, Mesa, AZ (US); Humberto Montoya Ramirez, JR., Spring, TX (US)

(72) Inventors: Ione Batilla Ryan, Houston, TX (US); Robert Mark Cormier, Mesa, AZ (US); Humberto Montoya Ramirez, JR., Spring, TX (US)

(73) Assignee: Ione Batilla Ryan, Houston, TX (US)

(21) Appl. No.: 13/573,273

(22) Filed: Sep. 7, 2012

(51) Int. Cl. F41H 5/04; C08G 18/06; B32B 37/12

(52) U.S. Cl. 89/36.02; 156/329; 528/85; 89/905

(57) ABSTRACT

A projectile-resistant transparent laminate comprising a rigid laminate subassembly having a strike side surface opposing a direction of an anticipated threat, and includes first and second rigid transparent lamina bonded together with a transparent, ether-based thermoplastic elastomer layer interposed therebetween, where the thermoplastic elastomer layer further includes a transparent polyurethane having an ultra-high modulus of elasticity. The projectile-resistant laminate also includes an energy absorbing subassembly including a transparent, quasi-thermoset layer cast from an aliphatic urethane bonded to the rigid laminate subassembly.

### BACKGROUND

1. Field

The present invention relates generally to transparent laminate structures for use in safety and security applications. Particularly, this invention relates to transparent laminate structures and a method of making same using an ultra-high modulus thermo-plastic elastomer as a stabilizer of rigid substrates, and a energy absorbing layer, and further, to transparent laminate structures formed from combinations of one of two modules, where one module includes a rigid laminate structure stabilized by an ultra-high modulus thermo-plastic elastomer, and a second module includes a energy absorbing layer.

2. Description of the Problem and Related Art

Impact resistant glass laminates were first introduced in the early 1900s and are well known in the art today for use in safety and security glass applications, and have been traditionally constructed using alternating layers of glass and plastic sheeting in the form of thermosets, or thermoplastics with adhesive and or heat bonding interlays. For example, bullet resistant glass is sometimes constructed with several glass sheets connected together with thin sheets of polyvinyl butyral, or polyester interposed there between with a polycarbonate or acrylic layer bonded on the inside face of the final glass sheet using a thermoplastic polyurethane layer. The polycarbonate or acrylic layer provides additional strength, and to a small degree, elasticity, to the glass upon impact but is used primarily to provide good resistance to spalling.

However, excessive layering of glass and polycarbonate or acrylic sheets creates problems. First, using such materials, the weight and thickness of the transparent laminar assembly requires a heavily engineered and reinforced support structure. Next, such laminar assemblies suffer delamination in the presence of heat, either localized heat from high-velocity projectile, heat from the bonding process, or ambient heat from, for example, desert environments. Additionally, current transparent laminar structures also suffer from other safety concerns such as leaching of biphenyl “A's”. Such characteristics decrease life cycle of the systems and structural stability, ultimately reducing or negating their effectiveness.

Other materials such as aromatics and ether-based have exhibited a great resistance to heat, and can provide desirable mechanical properties of greater elasticity and lighter weight. However, heretofore, such compositions have not been suitable for use in transparent armor because over time light transmissiveness degrades.

### SUMMARY

The present disclosure is directed to a transparent projectile-resistant laminate assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

It should also be noted that the term “projectile” may refer to any object that may strike the surface of a transparent assembly and cause degradation or failure. These may include projectiles such as bullets, shrapnel, thrown objects such as bricks, stones and other similar objects and self-propelled items such as RPG's, IED's, missiles, and other rocket like projectiles. Projectiles may also include objects that become self-propelled by an Act of God or nature as a result of severe weather conditions such as tornadoes, hurricanes, sand storms, typhoons and high winds. Projectiles may also include objects used to directly strike the surface of the assembly such as bats, bricks, metal objects, wooden clubs, etc. Projectiles may also include objects that come into contact with the transparent assembly if used in a vehicle and that vehicle was to become part of an accident or intentional hazard.

A projectile-resistant transparent laminate including a rigid laminate assembly with first and second rigid transparent lamina bonded together with a transparent, ether-based thermoplastic elastomer layer interposed therebetween. The thermoplastic elastomer layer, (VT-0124) is a transparent polyurethane having an ultra-high modulus of elasticity. VT-0124 is applied as a film and for this requirement to be between 3 mils to 10 mils in thickness. This layer increases the elasticity of the glass layers and substantially reduces the area of local gross deformation of the laminate. The laminate further includes an energy absorbing assembly that is a transparent, quasi-thermoset layer made from a cast aliphatic urethane. VT-0124 is manufactured by Bixby International, Newburyport, Conn. and offered by XO Armor® of Houston, Tex.

The earlier reference to ultra-high modulus, also known as the tensile modulus, is a measure of the stiffness of an elastic material and is a quantity used to characterize materials. High modulus materials contain longer molecular chains which serve to transfer load more effectively across the polymer and thereby strengthening intermolecular interactions. When used in conjunction with a proper cleaning and adhesion promoter the higher modulus value yields a deeper molecular bond between the organic and inorganic surfaces and thus provides stronger adhesion of the dissimilar materials. Within the art of laminating glass to polycarbonate or acrylic materials, of organic to inorganic materials there are known choices of adhesive products available. The most commonly of these used are polyvinyl butyral (PVB), aliphatic polyether polyurethane, and thermoplastic polyurethane. Table 1 depicts the higher modulus advantage of VT-0124 as 2.45 to 13.5 times higher as compared to other common interlayer alternatives.

TABLE 1

| Polymer Type | Range | Flexural Modulus (MPa) |
|---|---|---|
| VT-0124 | Ultra-High | 27.0- ASTM D-790 |
| Polyvinyl Butyral (PVB) | High | 11.0- ASTM D-5026 |
| Aliphatic Polyether Polyurethane | Low | 3.5- ASTM D-882 |
| Thermoplastic Polyurethane | Low | 2.0- ASTM D-412 |

These and other embodiments of the present invention will also become readily apparent to those skilled in the art from the following detailed description of the embodiments having reference to the attached figures, the invention not being limited to any particular embodiment(s) disclosed.

In addition the current invention also uses this same organo-silane and silicone glycol copolymer agent to promote the adhesion of optical glass film for film to glass, or film to polycarbonates and acrylics, and film to film utilizing the pressure sensitive adhesive or PSA that is applied to the film in an ambient temperature environment. The ambient temperature utilizing PSA applications would be considered novel as it would not be an obvious use of the solution to those skilled in the art.

As described in U.S. Pat. No. 4,364,786 issued to Smith, Jr. “the surface is treated with a dysfunctional organo-silane coupling agent such as Dow E 6020 at 0.2% in isopropanal” and then heated to 150 degrees Fahrenheit in order to dry and remove moisture. Smith further explains that “This silane treatment improves the adhesion properties of the glass blank. One end of the silane molecule to be chemically bonded to the interlayer of polyurethane.” Smith concludes the explanation of the silane coupling agent as “becoming molecularly bonded to the glass at one end of the silane molecule. The heating and pressure of the lamination causes the opposite end of the silane molecule to be bonded to the polyurethane. Thus molecular bonds securely attach the elastomeric layer to the glass.” As in U.S. Pat. No. 4,364,786 issued to Smith, Jr., the current invention, utilizes a silane agent comprising of an organo-silane and a silicone glycol copolymer (wetting agent) diluted in with water, preferably de-ionized water to facilitate the bonding of the of the organic glass to the inorganic thermoplastic layer.

In addition the current invention also uses this same organo-silane and silicone glycol copolymer agent to promoted the adhesion of optical films to glass or plastics, polycarbonates, acrylics and film to film utilizing the pressure sensitive adhesive or PSA that is applied to the film. The ambient temperature utilizing PSA applications would be considered novel as it would not be an obvious use of the solution to those skilled in the art.

In the preferred embodiment of the invention, the chemical composition is a silane-based mixture preferably containing additional components to enhance the strength properties of the structure as well as facilitate the application of the polyester or polyurethane polymer film onto the optical film. The silane used as a base compound in the mixture is preferably an emulsified silane, that serves as an adhesion promoter and binder which is similar to and complements the acrylic adhesive that is typically pre-applied on polyester and other plastic security films currently used to strengthen substrate materials, by bonding the plastic film to a substrate material. An added benefit of using an emulsified silane is that, unlike conventional acrylics, silane-based compounds are resistant to yellowing when repeatedly and extensively exposed to ultraviolet light. The silane-based adhesion promoters are also much smaller molecules than their acrylic-based counterparts, therefore the nano-sized silane compounds are able to penetrate deeper into the natural pores of the substrate material and polyester or polyurethane polymer film, thereby producing greater substrate material laminate adhesion. Silane chemistry is well known by those skilled in the art and will only be briefly discussed herein. Silane, otherwise known as silicane, is the silicon analogue of methane having four hydrogen atoms attached to the silicon atom. Like polymeric carbon compounds, silanes may also form saturated and unsaturated polymeric chains consisting of silicon and hydrogen atoms. Silanes may be gaseous or liquid compounds depending on the size and/or length of the polymer chain. Organofunctional silanes, or silanes with organic groups substituted in place of hydrogen groups, are particularly useful for their ability to bond organic polymer systems to inorganic substrates. The prepared silane-based chemical composition has a very low viscosity which is similar to the viscosity of water and lends itself to easy application in any known manner for water-based solutions. The preferred bonding and cleaning agent is a silane-based solution comprising an organofunctional silane to facilitate the bonding of the inorganic glass to the organic thermoplastic layer, and a silicone glycol copolymer that acts as a wetting and leveling compound. Further, the solution may be diluted with water, preferably de-ionized water. An example of a suitable bonding and cleaning agent is known as XO®BOND, offered by XO Armor®, LLP of Houston, Tex.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

The present invention takes advantage of utilizing a rigid subassembly to damage and begin to strip the outer jacket of an incoming projectile or object thus reducing its kinetic energy. The rigid assembly also begins erosion and/or ablation of the projectile tip further slowing the projectiles velocity. Upon entering the energy absorbing subassembly the projectile's velocity continues to dissipate as the energy of the projectile is broadly disbursed widely along the panel assembly and is finally prevented from penetrating the reverse side of the panel. There are numerous combinations of layers and lamina that could make up a ballistic panel to one skilled in the art of such and the mere addition or subtraction of layers or lamina of the products described herein would not stray from the original scope and intent of this invention. The drawings within this invention are not meant to limit these combinations, but only showcase the more obvious and practical methods of achieving transparent layered ballistic panel construction.

FIG. 1 is a sectional view of a rigid laminate assembly;

FIG. 2 is a sectional view of a transparent armor structure incorporating rigid laminate assemblies illustrated in FIG. 1 along with an energy absorption layer between.

FIGS. 3 through 8 are sectional views of other exemplary embodiments of a transparent armor structure, each incorporating a rigid laminate assembly and an energy absorbing layer; and

FIG. 9 is a perspective view a projectile resistant laminate assembly depicting a completed laminate structure.

### DETAILED DESCRIPTION

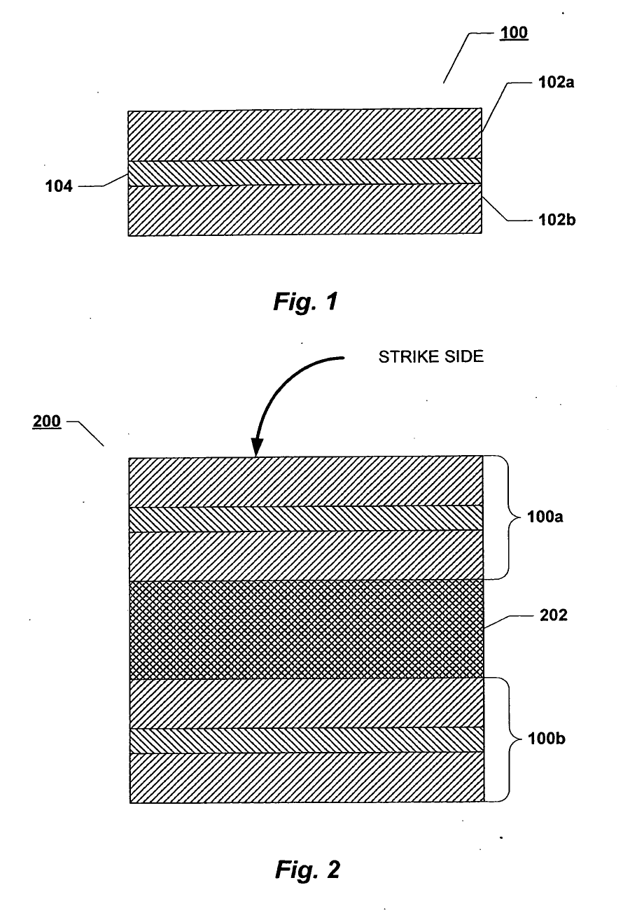

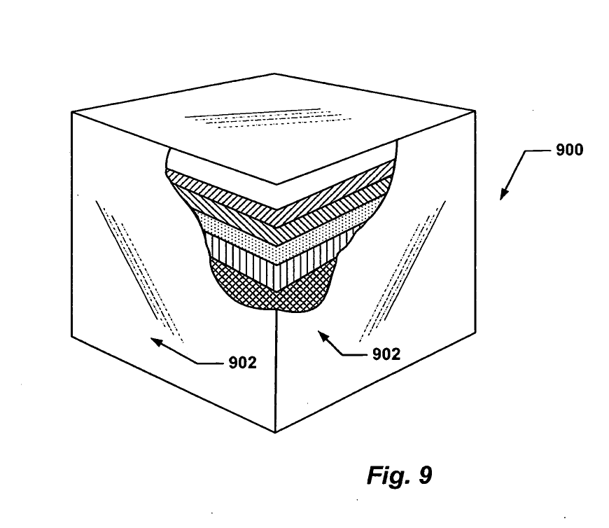

The various embodiments of the present invention and their advantages are best understood by referring to FIGS. 1 through 9 of the drawings. The elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described above are to be considered in all aspects as illustrative only and not restrictive in any manner. The various combinations of layers described within only represent the more obvious combinations possible and it is understood additional combinations would be obvious to those skilled in the art. The following claims rather than the foregoing description indicate the scope of the invention.

Referring to the drawings, FIG. 1 depicts a rigid laminate assembly 100 comprising a first layer of a rigid, transparent material 102a, a second layer of a rigid, transparent material 102b, in between which is a transparent thermoplastic elastomer layer 104 of an ultra-high modulus, super elastic shape memory thermoplastic polyurethane that bonds the two rigid layers 102 together. A laminate assembly 100 thickness of between about 0.093 inches to about 0.500 inches is sufficient for most applications; however, it is to be understood that the thicknesses of the components could be varied to suit the anticipated threat and installation design. Additionally, first and second rigid transparent layers 102 could be a glass, preferably annealed to increase its strength. A prototype embodying the principles described herein was achieved with the “STARPHIRE®” glass product sold by PPG Industries, Inc., of Pittsburgh, Pa. When borosilicate glass or the soda lime glass is used in this invention, it is preferable to chemically or thermally reinforce the glass in order to improve the impact resistance. Rigid, transparent layer 102 could also be a transparent polycarbonate or acrylic.

The thermoplastic elastomer layer 104 is an ultra-high modulus thermoplastic elastomer (“UHMTPE”) having super elastic shape memory. These characteristics are achieved with an aromatic polyether-based, rather than ester-based, thermoplastic, long-molecular chain, polyurethane, at about 96% by weight, and about 4% by weight of a stabilizer composition that includes an anti-oxidant and a light stabilizer. Those skilled in the relevant arts with the benefit of this disclosure will recognize that heretofore, ether-based polymers have not been used in glass and polycarbonate or acrylic laminations. This is because they breakdown in the presence of heat from the lamination process and from the environment. However, the inventors hereof have discovered the use of certain stabilizers counters these deleterious effects. Specifically, the anti-oxidant prevents thermally induced oxidation of polymers during coating and heat lamination, traps free radicals formed during heating in the presence of oxygen and prevents discoloration and change of mechanical properties incumbent to the polymer. In other words, mechanical properties such as elasticity, and light transmissiveness are maintained even in the presence of heat. An example of such anti-oxidant is a phenolic stabilizer offered by Ciba Specialty Chemical Corporation, Tarrytown, N.Y., under the trademark Irganox®.

The light stabilizer includes an ultra violet (UV) absorber and a hindered amine light stabilizer (HALS). The UV absorber filters harmful UV light and prevents discoloration that degrades light transmission and prevents delamination when heating. HALS also trap free radicals formed under heat and are primarily useful in maintaining surface properties such as gloss. HALS also prevents cracking and chalking of the polymer. When used together, they have a complimentary synergistic effect. One such light stabilizer is offered under the mark Tinuvin®, also by Ciba.

A suitable polyether-based thermoplastic polyurethane with such heat resistance, and light preservation as described above is VT-0124. The thermoplastic elastomer is applied as a film and for this application is to be between 3 mils to 10 mils in thickness. This layer increases the elasticity of the glass layers and substantially reduces the area of local gross deformation of the laminate assembly 100 at the point of impact. The laminate assembly is assembled by a conventional autoclave process using iterative application of heat e.g., of approximately 360° F. and pressure of approximately 60 psi. The autoclave process utilized vacuum to remove any trapped air within the laminate assembly while under heat to insure an optically clear transparent laminate.

Preferably, all bonded surfaces of the rigid layers 102a, b to which the thermoplastic elastomer layer is to be bonded are cleaned before the bonding process with a bonding and cleaning agent. A preferred bonding and cleaning agent is a silane-based solution comprising an organofunctional silane to facilitate the bonding of the inorganic glass to the organic thermoplastic layer, and a silicone glycol copolymer that acts as a wetting and leveling compound. Further, the solution may be diluted with water, preferably de-ionized water. An example of a suitable bonding and cleaning agent is known as XO®BOND, offered by XO Armor®, LLP of Houston, Tex.

Transparent armor of this disclosure include a variety of combinations using the above described rigid laminate assembly 100, and a backing energy distribution layer consisting of a cast quasi-thermoset. For example, a first embodiment of a transparent armor 200 is disclosed with reference to FIG. 2 where a first rigid laminate assembly 100a is bonded to a layer of cast optical grade quasi-thermoset 202 which is bonded to a second rigid laminate assembly 100b. The energy absorbing layer 202 may be between about 0.25 inches to about 0.5 inches thick. The energy absorbing layer material within this invention is referred to as VTM-1100. VTM-1100 is classified as a pseudo-polymer quasi-thermoset resin. VTM-1100 has distinct advantages over polycarbonates or acrylics commonly used within ballistic transparent panels. The chart below details some of the advantages to be considered within ballistic panel construction and design.

| Measure | VTM-1100 | Polycarbonate | Acrylic |
|---|---|---|---|
| MIL-STD-662F V50 Test | 1066 fps | 889 fps | 775 fps |
| Martens Hardness (HM) | 50 N/mm2 | 94 N/mm2 | 161 N/mm2 |
| Softening Temperature | 190 deg C. | 163 deg C. | 160 deg C. |
| Optical light transmission | 91% | 86% | 91% |
| Haze index | 0.30% | 0.80% | 1.00% |

The MIL-STD-662F V50 test is a standardized approach to statistical ballistic reliability where the material in question will prevent 50% of the test projectiles from penetration and allow 50% of the test projectiles to pass through the test panel. This test gives reliable measure to exact material thickness requirements to meet particular desired ballistic protocols. The higher outcome value means the test panel will provide protection at higher projectile velocities. The Martens Hardness (HM) test provides measured hardness of a material. In the case of an energy absorption layer within a ballistic panel that is laminated between hard layers, a consistent and soft material is desired so the kinetic energy can be more easily disbursed throughout the panel. The softening temperature test provides the temperature where the material in question begins to lose its consistent mechanical properties. In this case a higher temperature is desirable for the inner energy absorption layer to maintain mechanical adhesion and dissimilar material bonding under extreme conditions in hot weather. Optical light transmission is a measure of clear transparency where the higher the test value the more favorably clear the material is. In the case of VTM-1100 it compares as among best in class, and better in most categories making it a novel material. Finally, the Haze Index test evaluates the specific wide-angle-light-scattering and light-transmitting properties of planar sections of materials such as basically transparent polymers. In this test, a lower value is desired if transparency is the goal. A suitable optical grade quasi-thermoset energy absorbing layer which is of cast aliphatic urethane is offered by XO Armor® of Houston, Tex.

The quasi-thermoset material is a cast aliphatic urethane. Unlike true thermoset materials, this quasi-thermoset exhibits thermoplastic characteristics as far as flow, elasticity and “self-healing” shape memory properties.

The above-described laminate demonstrates extraordinary strength when loaded by energies associated with rigid body impactors, while resulting in a structure that is thinner and lighter than current transparent armors. At the same time, optical quality of the laminate is only minimally degraded, if at all.

During an impact event, a projectile strikes the strike face of the structure, impacting first the rigid laminate assembly 100. In essence, the rigid laminate assembly 100 acts to strip a projectile jacket, and dissipate kinetic energy. It also begins erosion and/or ablation of the projectile tip that further slows the projectile's velocity. The described ultra-high modulus property of the polyether-based thermoplastic elastomer provide stability to the rigid layers, and increases to some degree their elasticity, allowing the rigid layers 102 to bend significantly under impact loads without breaking. The polyether-based thermoplastic elastomer layer 104 also increases material interface between the rigid layers and allows for local impact energies to be dispersed and dissipated over a greater surface area thereby improving management of the impact event. This is a result of super elastic shape memory provided by the extremely long molecular chain associated with the polymer and is measured at a 27 in accordance with measurements contained in the ASTM D790. Therefore, substrate stability, superior optical qualities, and ability to withstand temperatures in excess of 200 degrees C. make the material uniquely well qualified for superior performance of this application.

Once the projectile travels through the rigid laminate assembly 100 it encounters the energy absorbing layer 202. Since the energy absorbing layer comprises a quasi-thermoset, it softens in response to the addition of heat, and exhibits elasticity and shape memory of a thermoplastic. As the projectile penetrates the energy absorbing layer 202, its energy is further dissipated, especially since the projectile tip has been blunted by its encounter with the rigid laminate assembly.

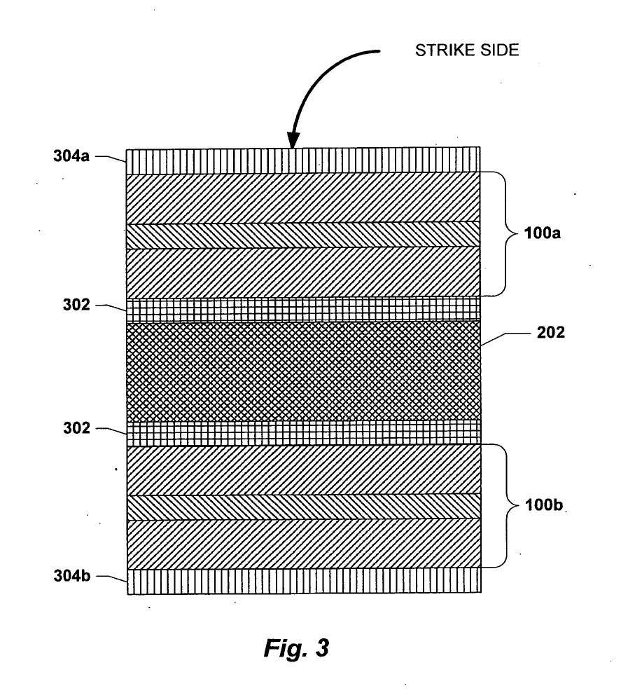

A further embodiment is illustrated by FIG. 3 where a first rigid laminate assembly 100a has an optical film layer 304a bonded to the outer surface thereof facing the direction from where the projectile might come, or the “strike side” indicated by the reference arrow. The optical film layer 304a is applied to a first rigid laminate assembly 100a. Again, an energy absorbing layer 202 is placed behind the first laminate assembly 100a, and ahead of a second rigid laminate assembly 100b, in between which are respective layers of an interlayer bonding material 302.

A second optical film layer 304b is bonded to the non-strike side surface of the second rigid laminate assembly 100b. Each optical film layer 304 may be comprised of two or more layers of a film, polyethylene terephthalate film (PET), and may be between about 0.04 mils and about 0.21 mils in thickness and comprise one or multiple layers of optical film depending on the application. Interlayer bonding material 302 may be between about 0.015 and about 0.050 inches and comprise another, secondary thermoplastic elastomer layer, to bond the rigid laminate assemblies 100 to either surface of the energy absorbing layer 202. In the alternative, interlayer material 302 may also be an aliphatic thermoplastic polyurethane film. Suitable materials include the above-described VT-0124, or the A4700 produced by Deerfield Urethane, of South Deerfield, Mass. Each of the layers may be bonded in a manner similar to that used for the rigid laminate assembly.

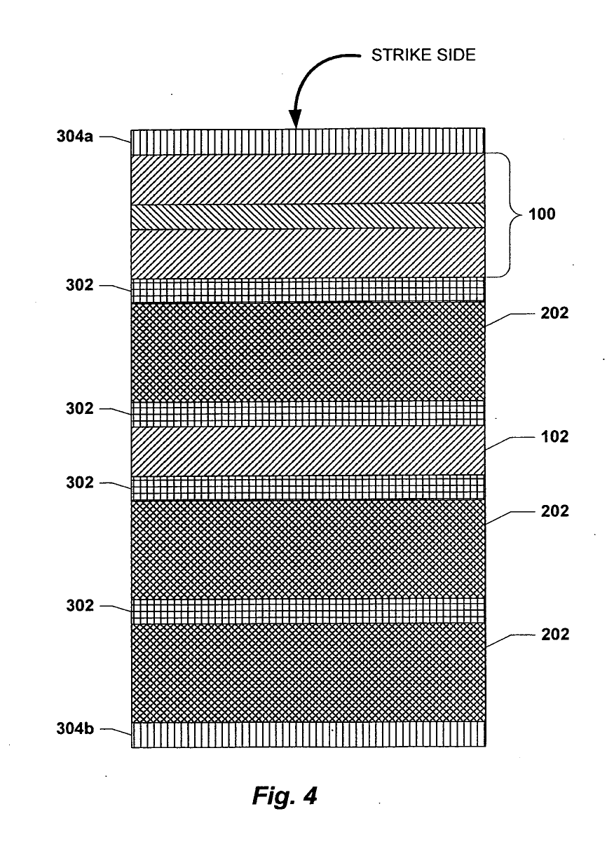

FIG. 4 illustrates a further embodiment includes a first film layer 304a bonded to the strike side of a rigid laminate assembly 100. Again an energy absorbing layer 202 is bonded to the opposing side of the rigid laminate assembly 100 and to which is bonded on its opposing side a rigid, transparent layer 102. This is followed by one or more layers of quasi-thermoset 202. Each of these layers is interleaved with layers of interlayer bonding material 302. Finally, the interior surface includes a second film layer 304b.

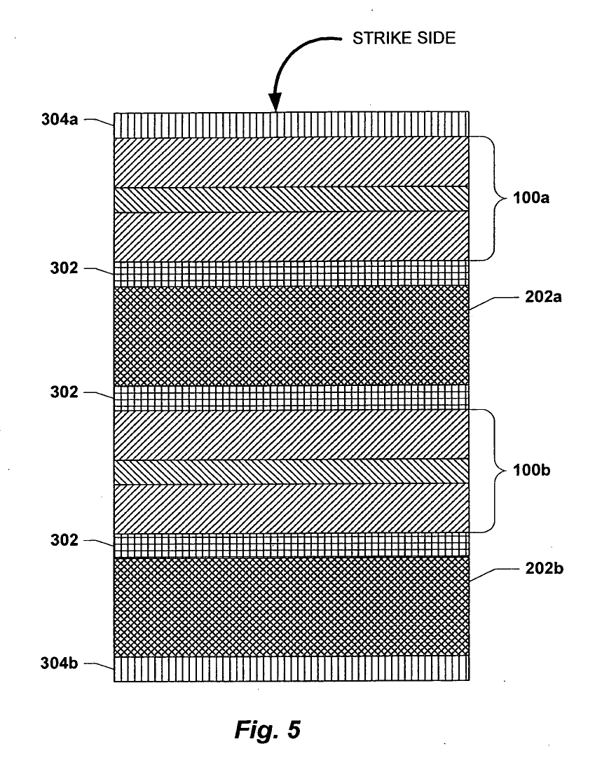

FIG. 5 illustrates a further embodiment wherein a first film layer 304a is bonded to the strike side surface of a first rigid laminate assembly 100a which is bonded to a first energy absorbing layer 202a with an interlayer bonding material 302 interposed therebetween. A second rigid laminate assembly 100b is bonded to the opposing side of the first energy absorbing layer 100a, again with an interlayer bonding material 302, and a second energy absorbing layer 202b is bonded to the opposing side of the second rigid laminate assembly 100b with another interlayer bonding material 302. Again, the interior surface of the transparent armor is overlaid with a second film layer 304b.

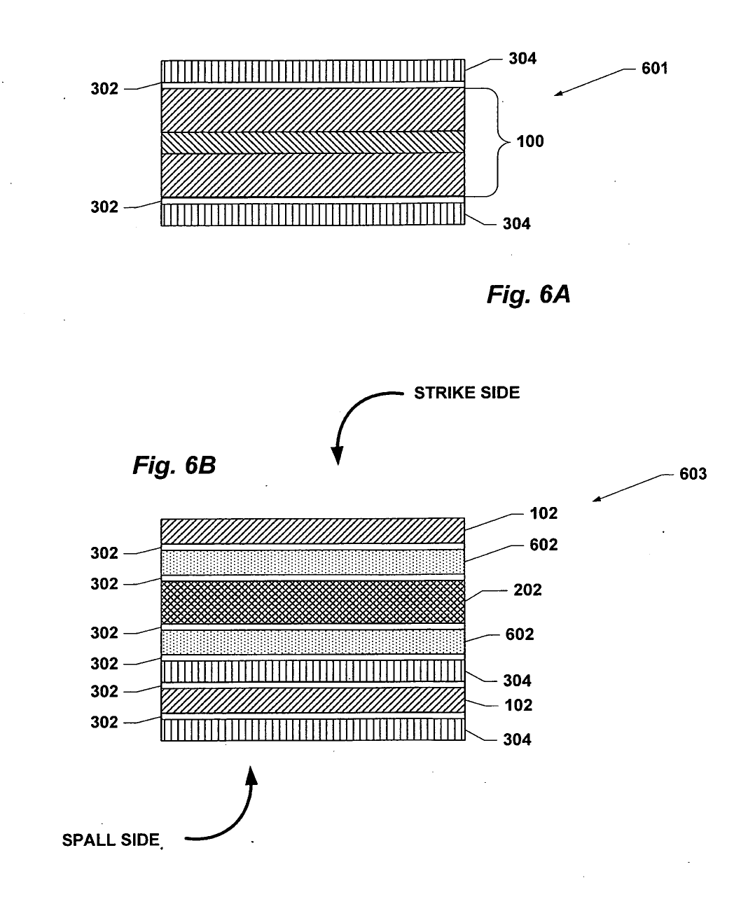

Further embodiment using components and principals described above is shown in FIG. 6A, 6B where a rigid module 601 is provided. Rigid module 601 is comprised of the rigid laminate assembly 100, sandwiched between one or more layers of optical film 304, with layers of interlayer bonding material 302 interposed therebetween. An energy absorbing module 603 is illustrated in FIG. 6B where in the energy absorbing layer 202 is sandwiched between sheets of polycarbonate or acrylic depending upon application 602 which may be between about 0.093 inches and about 0.500 inches in thickness, and bonded with respective layers of interlayer bonding material 302. In addition, toward the strike side, a layer of glass is bonded to polycarbonate or acrylic layer 602 with interlayer material 302, while on the inner side, a layer of glass sandwiched between two layers of optical film 304, and bonded with interlayer material 302 to the inward surface of the inner polycarbonate or acrylic layer 602.

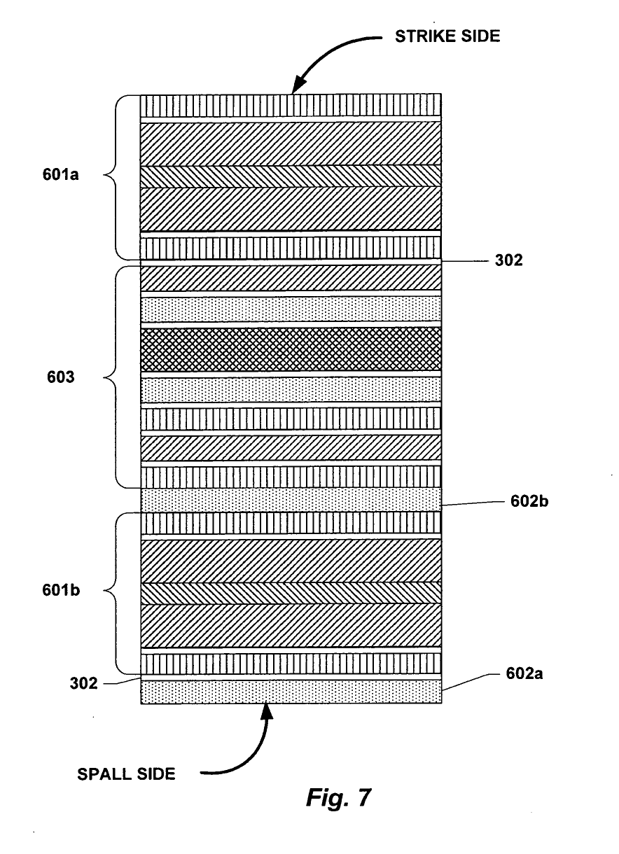

FIG. 7 shows an example of combining a rigid module 601 with an energy absorbing module 603 to achieve another embodiment of a transparent armor laminate. The laminate in FIG. 7 includes a strike side (indicated by reference arrow) and a spall side (also indicated by reference arrow), This version employs a first rigid module 601a facing the strike side, bonded to a energy absorbing module 603 with a layer of interlayer bonding material 302. A second rigid module 601b is stacked toward the spall side of the energy absorbing module 603. For bullet-resistant transparent laminate applications, regulations may require a layer of polycarbonate or acrylic layer 602a on the spall side to further mitigate splintering.

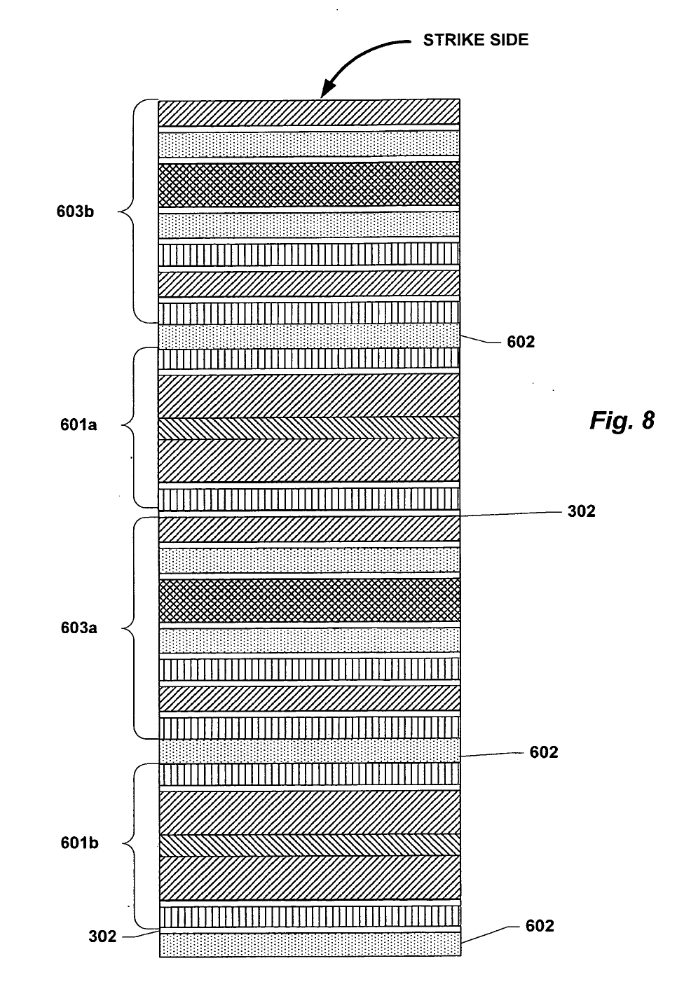

It may be advantageous to interpose a second polycarbonate or acrylic layer 602b between the energy absorbing module and the 601b without bonding. The inventors herein have discovered in prototype testing that the layering of different materials which vary in density, rigidity, and elasticity yields advantages in dissipating the kinetic energy of entering projectiles. Each time the projectile encounters a different material, its path alters somewhat, slowing its velocity. The lack of bonding between the intermediate polycarbonate or acrylic layer 602b and the energy absorbing module 603 and the second rigid module 601b results in an air gap on the order of microns in thickness which serves as yet a different medium through which the projectile passes and turns yet again. FIG. 8 shows a further embodiment wherein the laminate of FIG. 7 is appended with a second energy absorbing module 603b toward the strike side. Again, between the second energy absorbing module 603b and the first rigid module 601a a layer of polycarbonate or acrylic layer 602 may be placed as shown, and may be used without bonding material.

As described above and shown in the associated drawings, the present invention comprises a projectile resistant transparent laminate. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A projectile-resistant transparent laminate comprising:
a. A rigid laminate assembly further referred to as a rigid subassembly, composed of a dedicated strike-side surface facing the anticipated threat. The assembly lamina bonded together with a transparent ether-based thermoplastic elastomer layer comprising a polyether-based polyurethane having an ultra-high modulus of elasticity.
b. An energy absorbing laminate assembly further referred to as an energy absorbing subassembly, comprised of a quasi-thermoset layer derived from the casting of an aliphatic urethane. The energy absorbing subassembly is then bonded to the non-strike-side surface of the rigid subassembly to form the projectile-resistant transparent laminate.

2. A multi-layer organic to inorganic material bonding process involving the use of a specific nano-based bonding and cleaning adhesion promoting agent. The preferred bonding and cleaning adhesion promoter is a silane-based solution referred to as XO®BOND, utilizing an organofuctional silane-base to facilitate the bonding of the inorganic glass to the organic thermoplastic layer, and a silicone glycol copolymer that acts as a wetting and leveling compound. Further, the solution may be diluted with water, preferably de-ionized water. The result of this adhesion process and the specific use described herein of the silane-based bond promoter is a covalent bond.

3. A transparent polyurethane interlayer referred to as VT-0124, with an ultra-high modulus resulting in greater stability of the dissimilar transparent ballistic panel components and the promotion of dispersion of kinetic energy during an impact event.

4. VTM-1100, an optical grade quasi-thermoset energy absorbing layer which is of cast aliphatic urethane with physical properties of energy absorption and kinetic energy dispersion, self healing and shape memory properties.

5. A multi-layer film bonding process providing a molecular level covalent bond whereas multi-layers of similar or dissimilar optical films can be bonded together utilizing a silane-based cleaning and adhesion promoter, XO® BOND The silane-base solution facilitates the bonding of the similar or dissimilar film layers, and a silicone glycol copolymer that acts as a wetting and leveling compound. Further, the solution may be diluted with water, preferably de-ionized water. The result of this adhesion process and the specific use described herein of the silane-based bond promoter is a covalent bond.
